(19) United States
(12) Patent Application Publication
(10) Pub. No.: US 2015/0066783 A1
(43) Pub. Date: Mar. 5, 2015

(54) MEDIA SEARCH AND LICENSE SYSTEM AND METHOD

(71) Applicant: Protunes, Inc., Dublin (IE)

(72) Inventors: Declan Mohan, Dublin (IE); Bobby O'Reilly, Dublin (IE); Steve O'Connor, Dublin (IE)

(21) Appl. No.: 14/479,185

(22) Filed: Sep. 5, 2014

Related U.S. Application Data
(60) Provisional application No. 61/874,292, filed on Sep. 5, 2013.

(51) Int. Cl. G06Q 50/18; G06F 17/30

(52) U.S. Cl. CPC G06Q 50/184; G06F 17/30755
USPC 705/310

(57) ABSTRACT

An automated music industry solution for aggregated search and licensing of diverse music catalogs through the use of metadata and algorithmic search technologies connecting the diverse supply of music available for synchronization licenses and the daily demands of music and media professionals.

### CROSS-REFERENCE TO RELATED APPLICATION

This patent application claims the benefit of U.S. Provisional Patent Application Ser. No. 61/874,292, entitled “Media Search and License System and Method,” filed Sep. 5, 2013, which applications are incorporated in their entirety here by this reference.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

This invention relates to media search and license systems and methods.

### BACKGROUND

The music business provides many opportunities. Like any multi-billion dollar industry that has existed for a long period of time, it also faces many challenges. Professionals in the industry who license music daily for use in television, film and other media are presented with too much choice and no efficient method of searching multiple catalogs simultaneously. Content owners have no common indexing of supply and consequently previous aggregated search technologies have been inadequate.

Music is part of all types of media. Every time you hear music on a television program, a movie, a commercial, at trade events, in theatres, on a plane, on the web, video games, ringtones; somebody had to find that music and license its use. This is called a synchronization or sync license.

In the b2b section of the music industry, professionals license music daily. There are literally tens of millions of tracks to choose from and the supply is growing by tens of thousands every day, including a hugely diverse supply with thousands of different suppliers, from major and indie labels to specialist music suppliers and single composers. Depending on the usage (TV, Radio, National, Local . . . ), price points are equally diverse, ranging from a few dollars to several hundred thousand dollars.

This is part of the performance royalty section of the music industry and has been the only consistently profitable and growing section of the industry for years. Sales from CDs and downloads are now disappearing and earnings for music artists are now being replaced by touring, merchandise and licensing.

Music licensing has two income streams; the sync license and residuals.

A synchronization license (or sync license) is a music license that allows the license holder to “sync” music to some kind of media output. Often sync licenses are used for TV shows and movies, but any kind of visual paired with sound requires a sync license. A sync fee is the amount of money paid to secure that license. When a synchronization license is issued, this allows the user to reproduce musical composition “in connection with” or “in timed relation with” a visual image, e.g., motion picture, television, advertising etc. Synchronization fees are hugely variable and range according to the outlet used and the source of the content.

Residuals are payable whenever a production is played on TV, radio or other media and is payable by the broadcaster or venue. In the United States, sync fees are paid directly to the vendor while residuals are collected by performing rights societies such as ASCAP or BMI.

The global b2b music market is worth billions of dollars annually. In 2014, this is a $4 billion dollar a year business in advertising. With other media output such as TV broadcast, film and digital, this easily exceeds $11 billion a year. In spite of these huge revenues, the industry is a disorganized, arcane, archaic mess of gigantic proportion. Much of the $11 billion a year potential is not being realized because of outdated practices, bureaucracy, over-regulation, inefficiencies, overly complex administration and self-interest bodies that are no longer required.

The specific problems that plague the music and media industries fall primarily in three categories: discovery, licensing, and payment.

The discovery problem of finding and deciding on relevant music can be a murky mess, as illustrated by the tag cloud in FIG. 1A. With millions of tracks to choose from how does the music professional find anything? It's a process where a music supervisor or producer may spend hours or even days sifting through vast catalogs. Choice is not a problem. Discovery and finding relevant music is the issue. Music is indexed by words that describe the genre and the music itself, from featured instruments to tempo to mood and more.

The licensing problem involves complicated negotiations about specific rights with many different parties, as illustrated by the tag cloud in FIG. 1B. In many countries across the world, licenses are negotiated and processed by teams of music professionals: from music supervisors and producers to business affairs, accounts departments, legal and many more. It is hugely time consuming, costly and grossly inefficient.

The payment problem is a complicated web of paying multiple parties for multiple regions, as illustrated by the tag cloud in FIG. 1C. Payments to the creators of music get eroded by middlemen, from agents and sub-publishers to collections societies and more. In many cases only a fraction of the sync fee gets to the composer. When it comes to residual entitlements (payments after synchronization) the system falls down spectacularly.

For the foregoing reasons there is a need for an online solution that allows for relevant music searches that connect potential licensees and content owners that result in straightforward licensing agreements. As illustrated in FIG. 1D, this system should solve the primary problems of licensing to make each component manageable to ensure speed, relevance, and convenience in finding, licensing, and paying for music.

### SUMMARY

The present invention is directed to a system and method for searching and licensing media content. There are great difficulties in finding content and their owners in order to establish a licensing agreement. Therefore this invention sets forth a system that finds the most relevant searches through algorithm-based data extraction, connects potential licensees with content owners, and creates automatic or manual licensing agreements.

In particular, the system which is shown as an example hereto is one that can be used to search for music and create licenses with content owners in an efficient manner. The system creates a large database for the music provided by content owners, saving not only the standard metadata, but also analyzing and saving perceptual musical attributes, like mood and tempo, through algorithm-based MIR (Music Information Retrieval) data extraction. A potential licensee can search the database by metadata and MIR data, or they can use songs in the database or songs in their personal library to find songs with similar attributes.

The system allows a content owner to choose their own rates for libraries of music. The rates can be automatically applied or negotiated. Once all parties accept, a license agreement is created. This process of quickly finding relevant content, connecting potential licensees with content owners, and generating license agreements improves efficiency and reduces costs for all parties.

### BRIEF DESCRIPTION OF DRAWINGS

FIG. 1A is an obscured tag cloud illustrating the problems and confusion of media discovery;

FIG. 1B is an obscured tag cloud illustrating the problems and confusion of media licensing;

FIG. 1C is an obscured tag cloud illustrating the problems and confusion of the licensing payment process;

FIG. 1D illustrates a system that removes the problems and confusion of media licensing by providing an automatic online interface that connects potential licensees to content owners;

FIG. 2 is a diagram of an exemplary environment in which the present disclosure may be implemented;

FIG. 3A shows an exemplary flow chart of a music ingestion process in accordance with an embodiment of the present disclosure;

FIG. 3B shows an exemplary flow chart of a search process in accordance with an embodiment of the present disclosure;

FIG. 3C shows an exemplary flow chart of a media licensing process in accordance with an embodiment of the present disclosure;

FIG. 4 shows a high-level diagram of a computer that may be used to implement various aspects of the present disclosure in certain embodiments;

FIG. 5A shows an exemplary implementation of a licensee active project in accordance with an embodiment of the present disclosure;

FIG. 5B shows an exemplary implementation of a licensee active playlist in accordance with an embodiment of the present disclosure;

FIG. 5C shows an exemplary implementation of a licensee active search in accordance with an embodiment of the present disclosure;

FIG. 5D shows an exemplary implementation of a licensee sandbox in accordance with an embodiment of the present disclosure;

FIG. 6A shows sample filters and icons for searching media content in accordance with an embodiment of the present disclosure;

FIG. 6B shows an embodiment of a GUI for searching media content using existing media in accordance with an embodiment of the present disclosure;

FIG. 6C shows search results ranked from similarity to a seed file in accordance with an embodiment of the present disclosure;

FIG. 6D shows an embodiment of a GUI for searching media content using an existing library in accordance with an embodiment of the present disclosure;

FIG. 6E shows an embodiment of a GUI for searching media content using sliders relating to genre in accordance with an embodiment of the present disclosure;

FIG. 6F shows an embodiment of a GUI for searching media content using keywords in accordance with an embodiment of the present disclosure;

FIG. 7 shows a sample media catalog;

FIG. 8A shows a sample cart license list;

FIG. 8B shows a sample licensing page;

FIG. 8C shows a sample licensing form; and

FIG. 8D shows a listing of completed licenses.

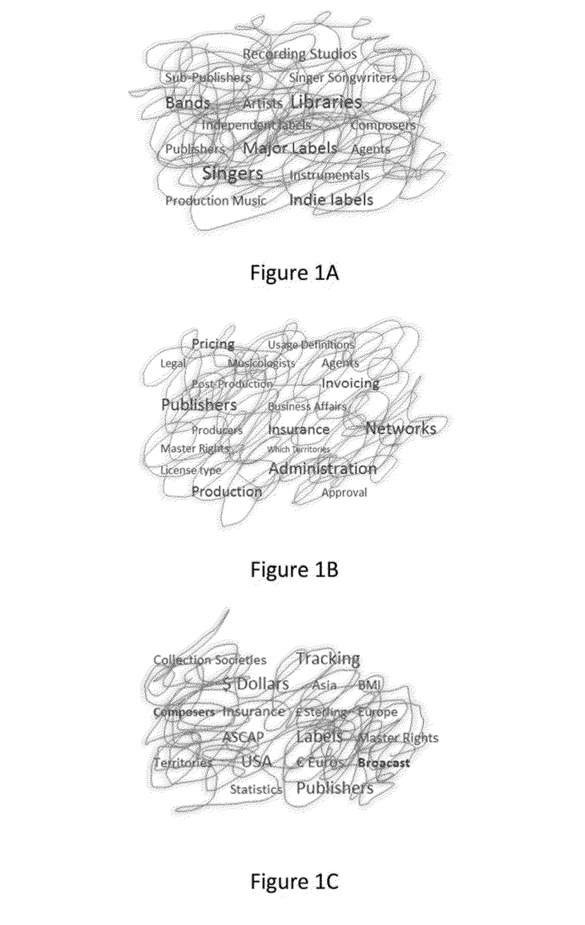

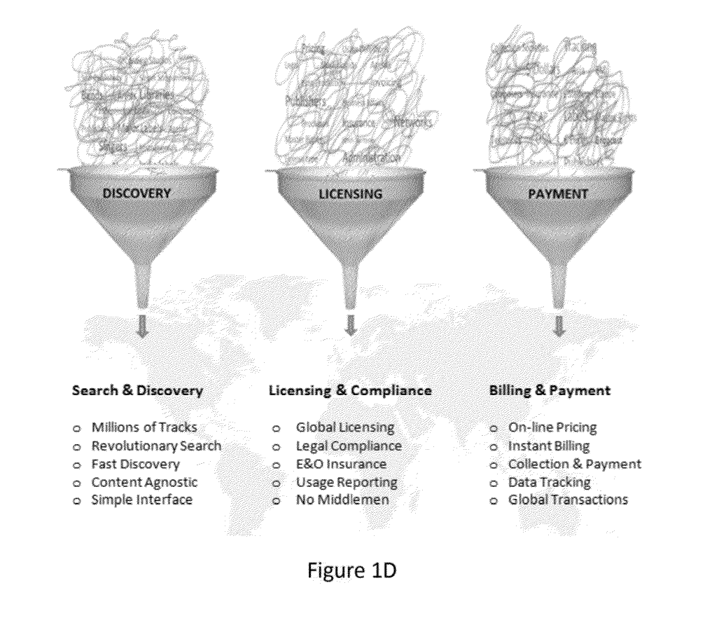

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The present invention is a sophisticated music search and licensing system that effectively encompasses supplied traditional metadata and new search technologies. The present invention provides an innovative algorithm-based music search that is used for each piece of music on the site. The algorithm and associated technologies capture standard metadata as entered by the content owner but also the previously intangible descriptors such as “mood” and “feel” as searchable metadata fields extracted by the proprietary analytical process.

The analysis of music content provides multiple points of reference data that allows the music industry professional to find relevant music. In addition, users who typically experience congestion with metadata search methodologies when faced with too many tracks can now search several million tracks without difficulty, in seconds. At present, the more music on traditional music search sites the more difficult it is to find anything and the fewer opportunities available for individual tracks to be surfaced. The solution displays results graded by relevancy which become more specific with a greater volume of music.

Global content owners are presented with an opportunity to surface and commercialize existing catalogs and previously unexploited tracks. Aggregated statistics generated by the site about usage, search and browsing habits will have significant commercial value and could be monetized within the guidelines of relevant data protection acts.

To mitigate the incremental activity and costs associated with user acquisition, the system uses a portal whereby large industry music buyers could search and license music via a central hub. This would have the added benefits of cost saving, administrative and system efficiencies and data monitoring.

Many large corporations such as film studios, broadcast networks, and advertising agencies have operations across the globe and annual music license expenditures in the tens of millions of dollars or more. The attraction for the agencies are many and include branded portals, sophisticated management tools, preferred content pricing and “it's free”. The system will benefit by locking in significant market leaders and leveraging that potential to increase its b2b user acquisition.

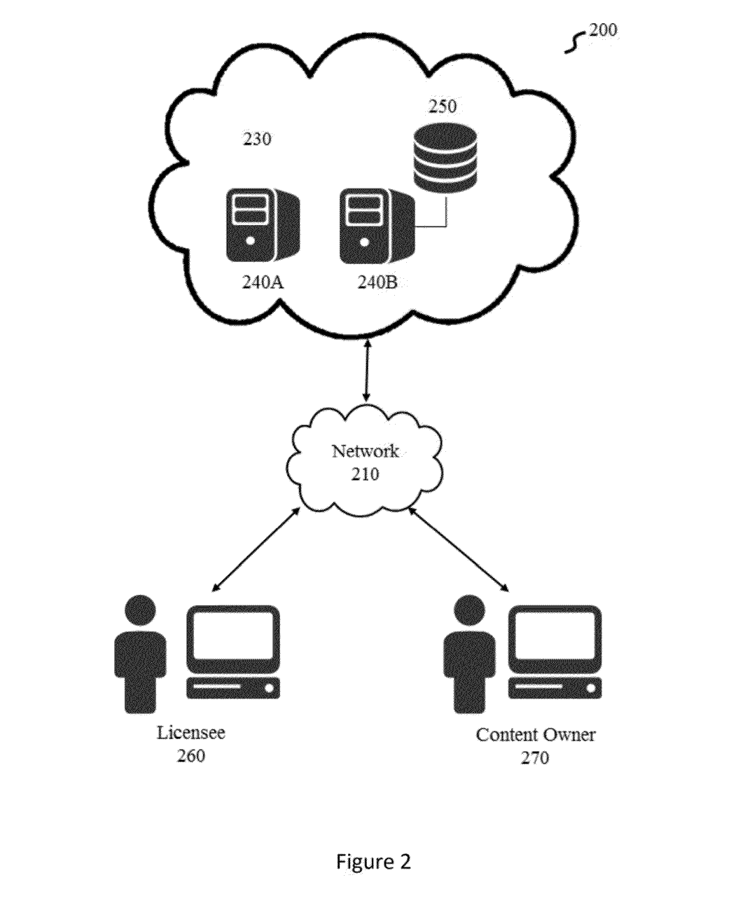

FIG. 2 illustrates an exemplary environment 200 in which the present disclosure may be implemented. A computing system 230 includes servers/databases that hold media and provide an interface to allow media ingestion, searches, and licensing. The servers 240A, 240B can provide multiple services. For example, servers 240A, 240B can provide access to websites, user databases, and interfaces for different types of applications and devices. Servers 240A, 240B can include virtual computing and/or storage resources. Databases 250 may hold different types of data, such as media data, search data, fingerprint data, user login information, user projects, licenses, and the like. Content providers 270 access the computing system through a network, like the Internet, and register media that may be searched and licensed. Licensees 260 access the computing system through a network to search and license media.

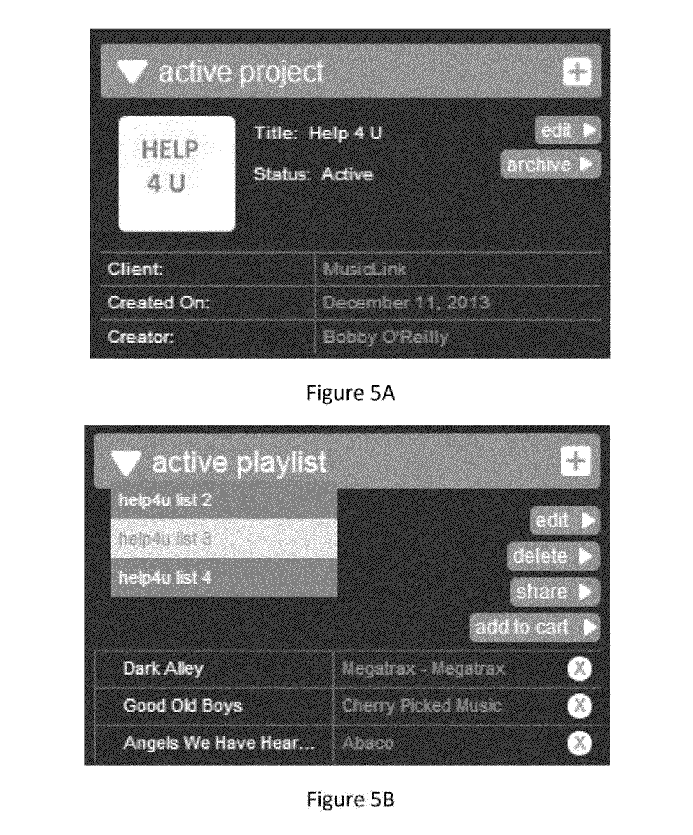

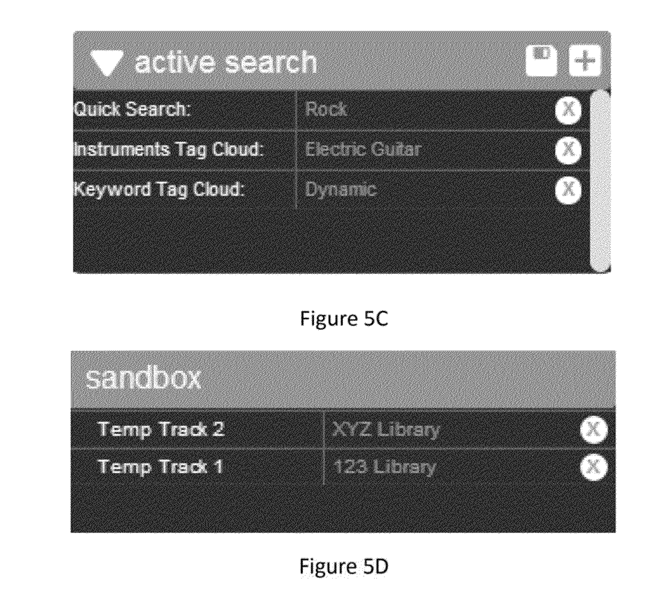

In an exemplary embodiment of the present invention, media is registered to the system by the content owners 270 through a process called media ingestion. The system uses a media ingestion process store the media and data for searching and licensing. As shown in the flow diagram in FIG. 5, the media ingestion process includes, but is not limited to, assigning a media ID to the media, processing the metadata, fingerprinting the media, checking for duplicates, watermarking the media, analyzing media for underlying attributes, such as MIR data, and maintaining a search database, fingerprint database, and media storage database. A content owner may provide additional information relating to each piece of media, including an automatic price for licenses. Once media is ingested in this way, it is available to be searched and licensed.

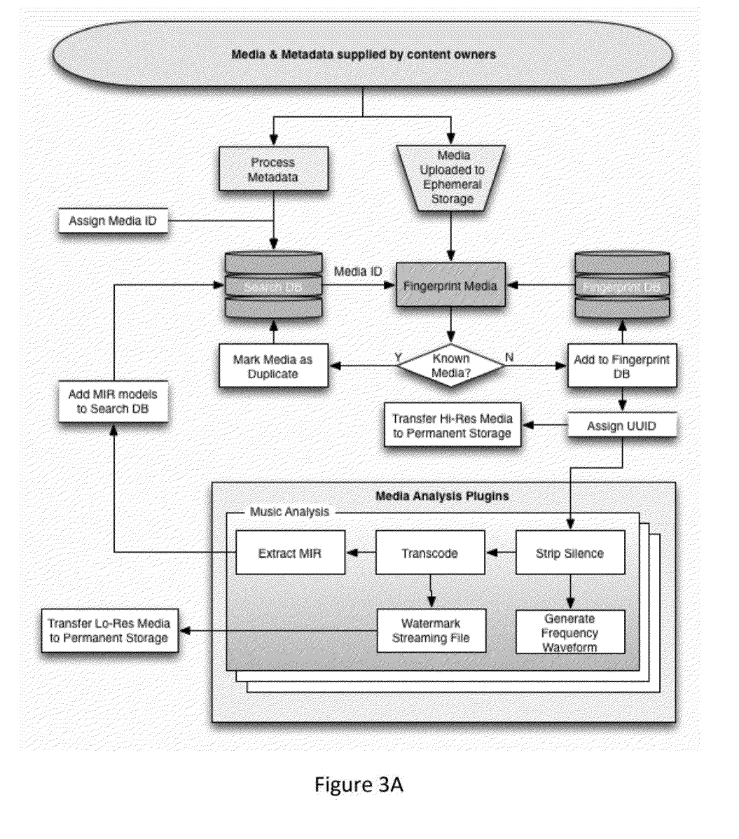

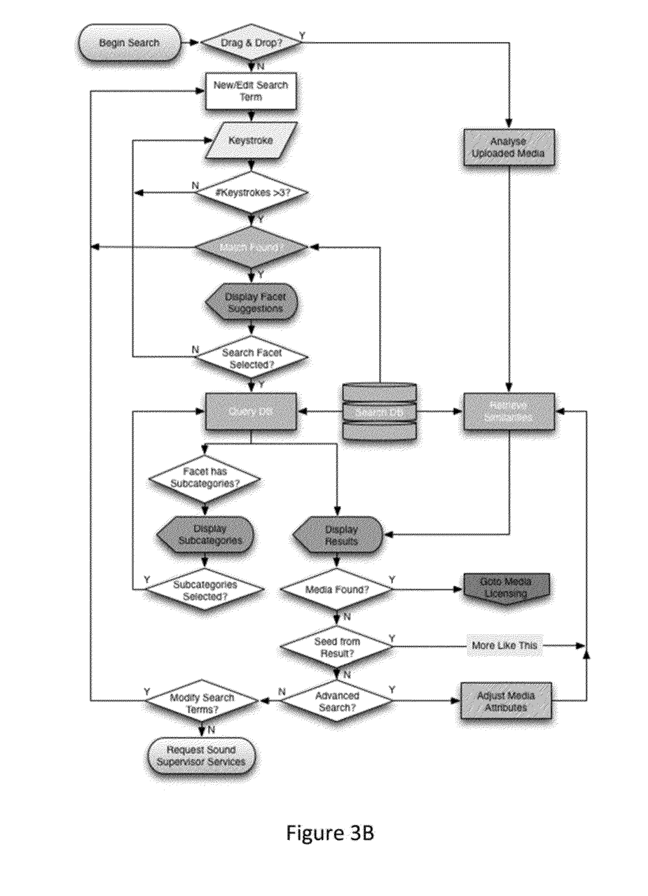

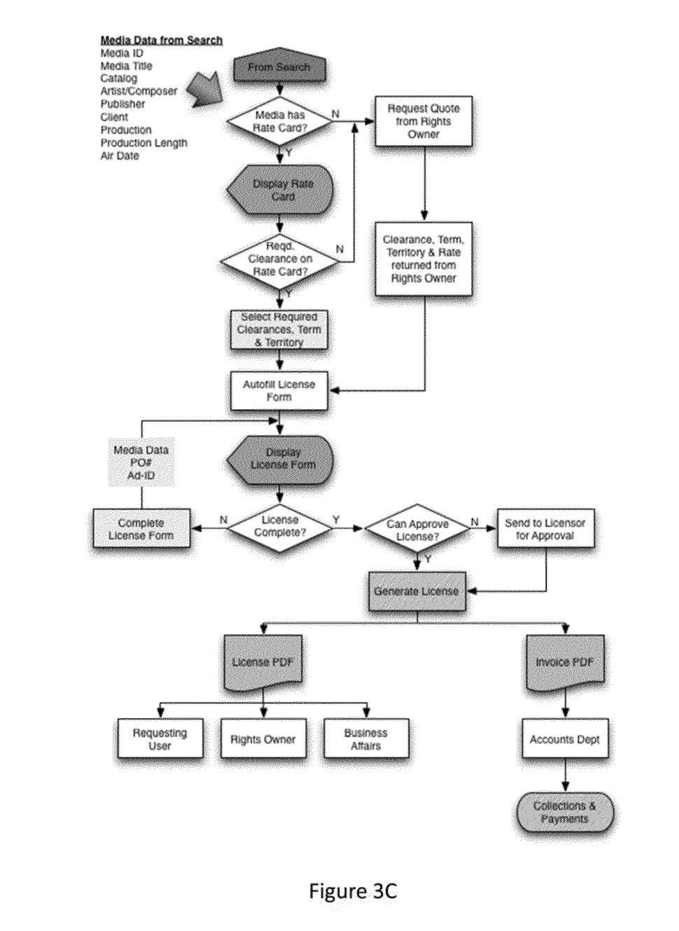

A potential licensee wishing to search for media to license would access the system through a network. The system would receive the potential licensee's search request and perform a search for relevant media. As shown in the flow diagram in FIG. 3B, a potential licensee may search among any number of ways, including but not limited to using a media file to search, entering search terms, choosing from a catalog, entering metadata, or other such attributes. A potential licensee may create a list of media before moving on to the licensing process.

Using such a dynamic suite of technology solutions can assist in finding relevant media faster and easier. While using music information organized by bibliographic metadata such as title, composer, genre, performer etc. is useful, new techniques such as using media to find other media in this system may provide faster and more relevant search results. For example, the affective aspect of music (popularly known as music mood) has been identified by recent behavioral studies* as an important criterion in music search and organization but most existing music repositories do not support access to music by mood. *“Combining text and audio for mood classification in Music Digital Libraries” Xiao Hu, University of Illinois ISSN 1937-7266. The system can use a digital signal processing analysis to identify multiple media attributes. For example, in a music track, this may include the tempo, density, timbre, nature, tone, percussion, and other music attributes.

By analyzing, identifying, and storing such information in a search database, new media may be analyzed and compared to the search database to find the most relevant search results faster than before. In some embodiments, a potential licensee uploads media using a drag and drop feature to find relevant data. In other embodiments, a potential licensee chooses media in the media database and searches for related media.

The system's license engine is a sophisticated method of assimilating user data and content license information automatically from the system to enable sync and other licenses to be generated automatically online with minimal user engagement, as shown in FIG. 3C. This simplifies the process traditionally associated with licensing by removing delays within the approval process. The system authorized users are qualified to license on the system and no further approval is required by content owners in advance of a sync license being issued.

In some embodiments, content owners may omit automatic licensing rates for media. A potential licensee may request a quote from the rights owner to attempt to form a license. Once the client and the content owner agree to terms and conditions, this is input into the system to generate the license forms. As shown in FIG. 3C, once a license is formed, all relevant parties are sent a copy of the license, and billing information is sent to the accounts department.

In various embodiments, the method steps described herein, including the method steps described in FIGS. 3A-3C, may be performed in an order different from the particular order described or shown. In other embodiments, other steps may be provided, or steps may be eliminated, from the described methods.

Systems, apparatus, and methods described herein may be implemented using digital circuitry, processors, memory units, storage devices, software, and other components. Typically, hardware includes a processor for executing instructions and one or more memory for storing instructions and data. Hardware may also include, or be coupled to, one or more storage devices, such as one or more magnetic disks, internal hard disks and removable disks, optical disks, etc.

Systems, apparatus, and methods described herein may be used within a network-based cloud computing system. In such a network-based cloud computing system, a server or another processor that is connected to a network communicates with one or more client computers via a network. For example, a client computer may communicate with the server via a network browser application residing and operating on the client computer. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the steps of the methods described herein, including one or more of the steps of FIG. 3A-3C, may be performed by a server and/or by a client computer in a network-based cloud computing system, in any combination.

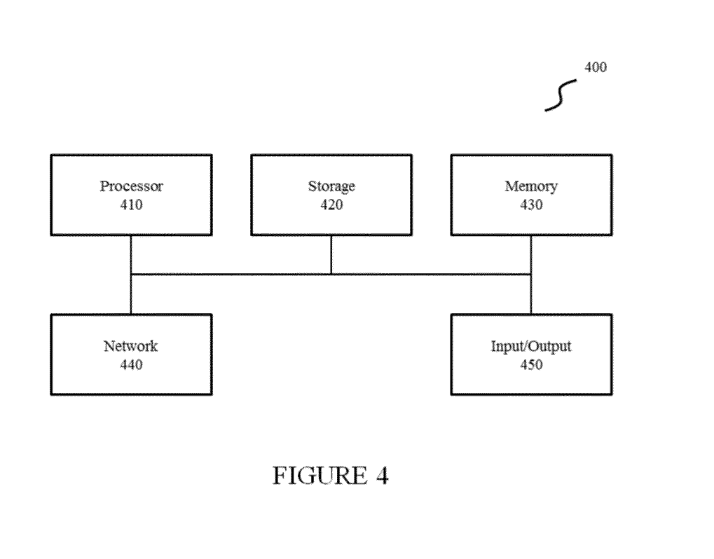

A high-level block diagram of an exemplary computer 400 that may be used to implement systems, apparatus, and methods described herein is illustrated in FIG. 4. The computer 400 comprises a processor 410 operatively coupled to a data storage device and memory. Processor 410 controls the overall operation of computer 400 by executing computer program instructions that define such operations. The computer program instructions may be stored in data storage device 420, or other non-transitory computer readable medium, and loaded into memory 430 when execution of the computer program instructions is desired. Thus, the method steps of FIGS. 3A-3C can be defined by the computer program instructions stored in memory 430 and/or data storage device 420 and controlled by processor 410 executing the computer program instructions.

For example, the computer program instructions can be implemented as computer executable code programmed by one skilled in the art to perform an algorithm defined by the method steps in FIGS. 3A-3C. Computer 400 also includes one or more network interfaces 440 for communicating with other devices via a network. Computer 400 also includes one or more input/output devices 450 that enable user interaction with computer 400 (e.g., display, keyboard, touchpad, mouse, speakers, buttons, etc.).

Processor 410 can include, among others, special purpose processors with software instructions incorporated in the processor design and general purpose processors with instructions in storage device 420 or memory 430, to control the processor 410, and may be the sole processor or one of multiple processors of computer 400. Processor 410 may be a self-contained computing system, containing multiple cores or processors, a bus, memory controller, cache, etc. A multi-core processor may be symmetric or asymmetric. Processor 410, data storage device 420, and/or memory 430 may include, be supplemented by, or incorporated in, one or more application-specific integrated circuits (ASICs) and/or one or more field programmable gate arrays (FPGAs). It can be appreciated that the disclosure may operate on a computer 400 with one or more processors 410 or on a group or cluster of computers networked together to provide greater processing capability.

Data storage device 420 and memory 430 each comprise a tangible non-transitory computer readable storage medium. By way of example, and not limitation, such non-transitory computer-readable storage medium can include random access memory (RAM), high-speed random access memory (DRAM), static random access memory (SRAM), double data rate synchronous dynamic random access memory (DDRRAM), read-only memory (ROM), erasable programmable read-only memory (EPROM), electrically erasable programmable read-only memory (EEPROM), flash memory, compact disc read-only memory (CD-ROM), digital versatile disc read-only memory (DVD-ROM) disks, or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Network/communication interface 440 enables the computer 400 to communicate with networks, such as the Internet, also referred to as the World Wide Web (WWW), an intranet and/or a wireless network, such as a cellular telephone network, a wireless local area network (LAN) and/or a metropolitan area network (MAN), and other devices using any suitable communications standards, protocols, and technologies. By way of example, and not limitation, such suitable communications standards, protocols, and technologies can include Ethernet, Wi-Fi (e.g., IEEE 802.11), Wi-MAX (e.g., 802.16), Bluetooth, near field communications (“NFC”), radio frequency systems, infrared, GSM, EDGE, HS-DPA, CDMA, TDMA, quadband, VoIP, IMAP, POP, XMPP, SIMPLE, IMPS, SMS, or any other suitable communications protocols. By way of example, and not limitation, the network interface 440 enables the computer 400 to transfer data, synchronize information, update software, or any other suitable operation.

Input/output devices 450 may include peripherals, such as a printer, scanner, monitor, etc. Input/output devices 450 may also include parts of a computing device, such as a smartphone having a touchscreen, speakers, and buttons. For example, input/output devices 450 may include a display device such as a liquid crystal display (LCD) monitor for displaying information to the user, a keyboard and mouse by which the user can provide input to the computer 400, or a touchscreen for both input and output.

Any or all of the systems and apparatus discussed herein, including personal computers, tablet computers, hand-held devices, cellular telephones, servers, database, cloud-computing environments, and components thereof, may be implemented using a computer such as computer 400.

One skilled in the art will recognize that an implementation of an actual computer or computer system may have other structures and may contain other components as well, and that FIG. 4 is a high level representation of some of the components of such a computer for illustrative purposes.

FIGS. 5A-5D show an example user interface for a client to manage media for licensing purposes. In this embodiment, a client organizes a collection of media in projects and playlists as shown in FIGS. 5A and 5B. A project may hold multiple playlists, and a playlist may hold multiple media files. A client may search for media, as shown in FIG. 5C, and immediately store it in a playlist, or temporarily store in a sandbox in order to assign it to a playlist later, as shown in FIG. 5D. These tools are useful for a client in order to organize and license music at the same time.

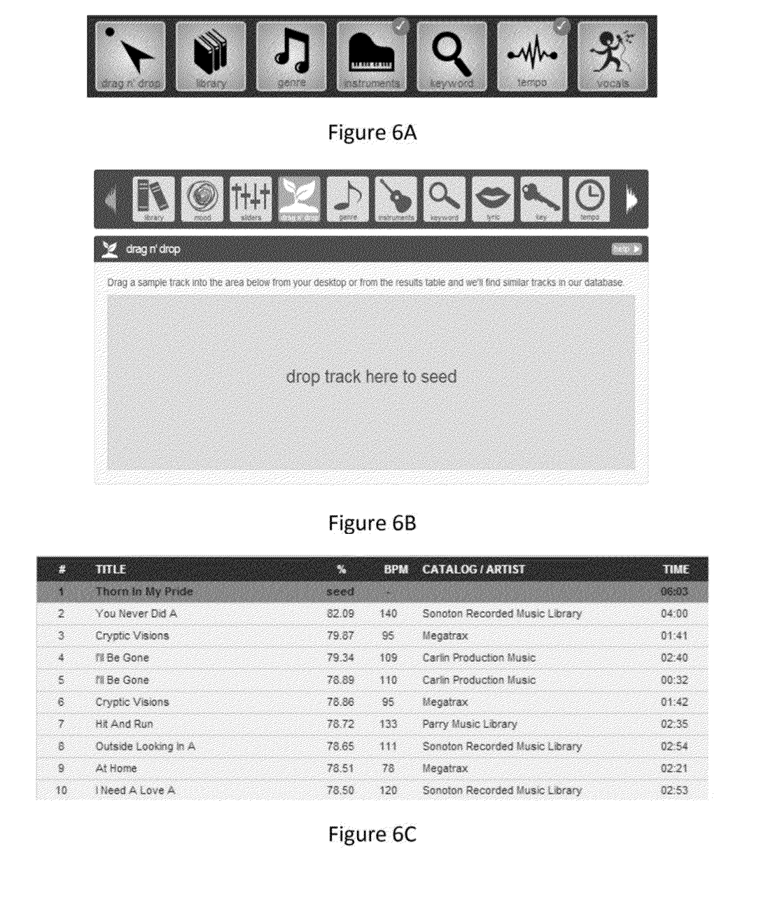

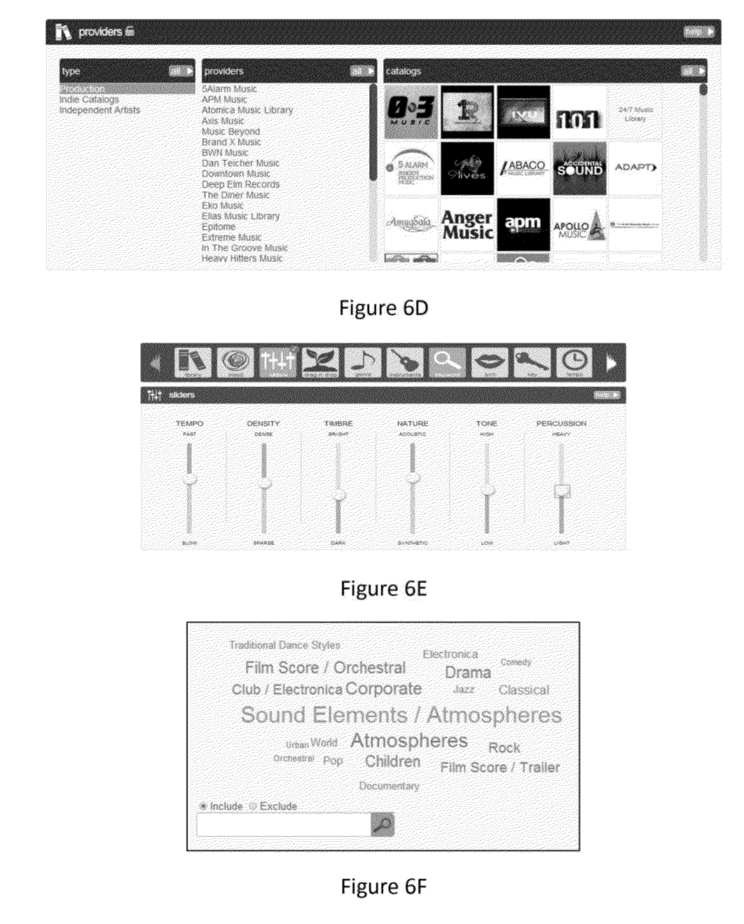

FIGS. 6A-6F show embodiments of search techniques in finding media to license. In the sample embodiment shown in FIG. 6A for music, these search techniques include “drag n′ drop,” library, genre, instruments, keyword, tempo, vocals. Multiple search techniques/filters may be used in conjunction when conducting searches.

The drag and drop search technique, as shown in FIG. 6B, allows a user to drop a media file from the user's computer, from the system's catalog, or from some other source in order to find related media files. The media file is ingested, analyzed, and a search is conducted for related media. FIG. 6C shows a sample search result from such a search, and shows the most related media files. The similarity of the media files is shown as a “seed %” and relates the similarity of media to the searched media.

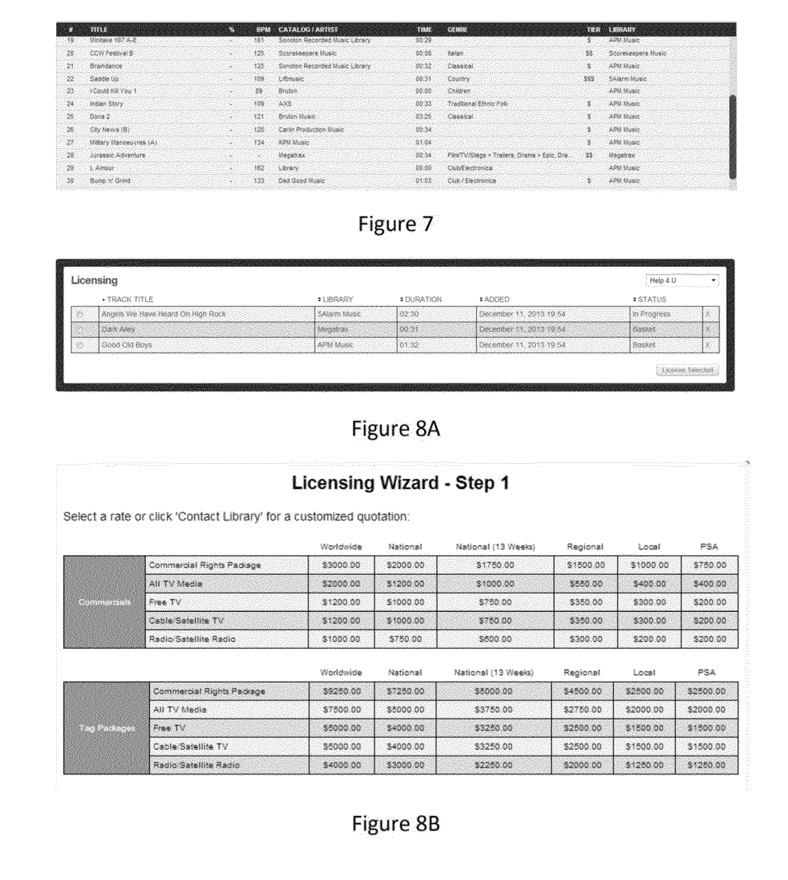

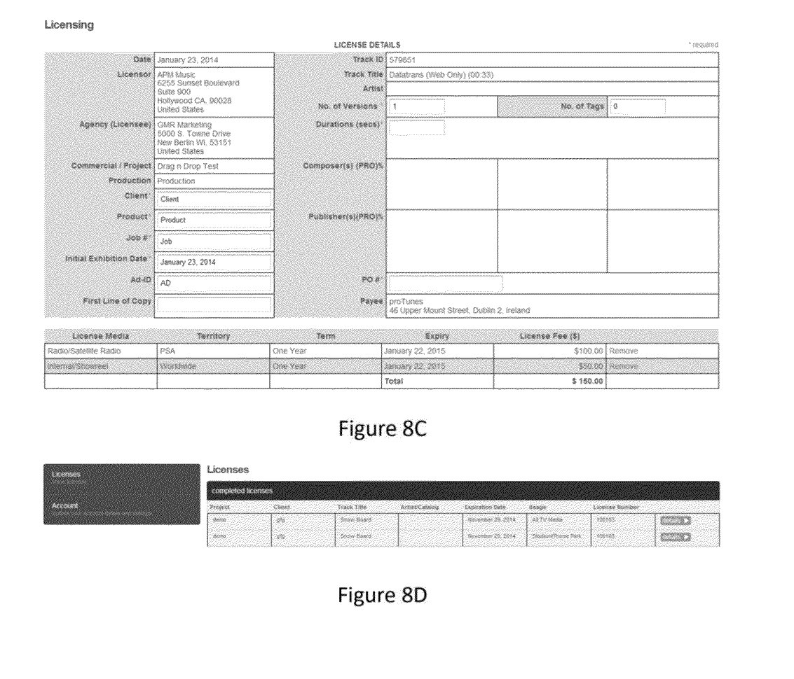

FIG. 6D shows a sample library catalog in the system. A user may browse the selection by type, provider, or any other relevant category. FIG. 6E shows a sample search using by using sliders. In this example, sliders are a proprietary interface which enables music already in the system to be sorted according to tempo, density, timbre, nature (acoustic vs. synthetic), tone and percussive qualities. FIG. 6F shows an example keyword search. In this example, a tag cloud is shown, and a user may choose to include or exclude certain tags. When choosing media to license, a price or price tier may be shown, as in FIG. 7. This is useful to indicate which media can be instantly licensed, as well as how much it will cost.

[License] FIGS. 8A-8D show an embodiment of the licensing process. FIG. 8A shows a sample cart license list. The cart license list may show media that a user desires to license. FIG. 8B shows a sample implementation of a selection of rates. As shown, content owners may post license rates for different markets. A potential licensee chooses the appropriate market and rate indicated in order to generate a license. FIG. 8C shows a sample of a licensing form that a licensee fills out to generate the license. Most of the license information is gathered automatically from the system. The user fills out the remaining fields. Once generated, a user may view successfully completed licenses in a user interface, such as the dashboard shown in FIG. 8D.

In some embodiments, the licensing forms may be saved for future completion or authorization. In some embodiments, multiple licenses may be generated from one form. In some embodiments, additional steps may include receiving access permission or authentication from an authorized user before completing the license.

In some embodiments, a user may wish or need to contact a content owner directly. A user may still enter as much detail as desired into the prepopulated forms in order to expedite the licensing process with the content owner. Once an agreement is formed, the parties may generate a license using the system.

In some embodiments, this model is implemented so that content owners may participate for free. In some embodiments, the system does not charge professional user groups to search and discover music. In some embodiments, the system only charges a transaction fee on successful licenses. This removes the entry barrier to getting content or users on the system. In some embodiments, the system introduces an aggregated tiered rate card system to online licensing. Specific libraries of music may utilize their own rate card or for the “portal” model may subscribe to a client negotiated flat rate card system. This improves the efficiency of license transactions and significantly reduces the overhead and cost of sales for content owners and content creators.

This system may also provide insurance for content on the system, as well as individual sync transactions. This first of its kind insurance developed in conjunction with the insurance industry and will protect all licensees whether the content being licensed has existing insurance or not.

The system and method which is shown in the sample embodiments is applied to music searching/licensing, but may also be applied to other markets as well. Other content may be searched and licensed in a similar way with this process including audio sound effects, music sample catalogs, images, video, books and documents. This content could potentially be used in one system to combine and preview content to determine which content to license. This system and method are particularly important when a licensee may have difficulty searching a large marketplace of content, finding content owners, and licensing the content.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A system for media search and licensing, comprising:
a. at least one processor;
b. at least one media database;
c. at least one search database;
d. at least one user interface;
e. a media ingestion module, wherein the media ingestion module comprises instructions that when executed by the at least one processor, cause the at least one processor to receive media and licensing information, store the media and licensing information in the at least one media database, analyze the media for searchable attributes, and store the searchable attributes in the at least one search database;
f. a search module, wherein the search module comprises instructions that when executed by the at least one processor, cause the at least one processor to receive a search request from the at least one user interface, perform a search in the at least one search database based on the search request, and send search results to the at least one user interface;
g. a licensing module, wherein the licensing module comprises instructions that when executed by the at least one processor, cause the at least one processor to receive a license request from the at least one user interface, wherein the license request comprises a request relating to at least one media and licensing information;
i. wherein if the licensing information comprises automatic licensing rates for automatic licenses, generate an automatic license;
ii. wherein if the licensing information does not comprise automatic rates for automatic licenses, prepare a request to an owner of the at least one media.

2. The system of claim 1, wherein the media is music, wherein the searchable attributes comprises MIR (Music Information Retrieval) data, wherein the search request comprises a music file, and wherein the search module searches for music that has similar MIR data to the music file.

3. The system of claim 1, wherein the system further comprises a user database and a playlist module, wherein the playlist module is operable to store media in a playlist associated with a user.

4. The system of claim 3, wherein the search module is operable to receive a playlist and return similar media with lower licensing rates.

5. A system for media search and licensing, comprising:
a. at least one processor;
b. memory;
c. at least one database; and
d. at least one program, wherein the one or more programs are stored in the memory and configured to be executed by the at least one processor, the at least one program including instructions to:
i. receive and store media and licensing information in the at least one database from at least one content owner,
ii. provide a search interface for clients to search for media to license;
iii. receive a request from a client to license media stored in the at least one database; and
iv. generate a license between the client and at least one content owner.

6. The system of claim 5, wherein the media is music, wherein media is analyzed to determine MIR (Music Information Retrieval) data and stored in the at least one database, wherein the search interface is operable to search by inputting music, wherein the music is analyzed to determine MIR data, and wherein the search interface is operable to search by MIR data.

7. The system of claim 5, wherein the system automatically generates a license when the request to license media identifies media with automatic rates.

8. The system of claim 7, wherein the system provides a contact form to the client to contact the content owner when the request to license media identifies media without automatic rates.

9. The system of claim 8, wherein the system provides a contact form to the client to contact the content owner upon the client's request.

10. The system of claim 9, wherein the search interface provides a catalog of media available and filtering tools to find media;

11. The system of claim 10, wherein the search interface is operable to save playlists of media in a cart before checkout.

12. The system of claim 11, wherein automatic licensing rates are dependent on region and use.

13. A method for media search and licensing, comprising:
a. receiving and storing media and licensing information from a content owner into at least one database;
b. providing a user interface for a client, wherein the user interface is operable to search the database for media to license;
c. receiving a request from the client to license media stored in the at least one database; and
d. generating a license between the client and content owner.

14. The method of claim 13, wherein the media is music, wherein the method further comprises analyzing media for MIR data, storing the MIR data in the at least one database, receiving client media as an input to the user interface, analyzing the client media for MIR data, and searching the database by the client media MIR data.

15. The method of claim 13, wherein generating a license between a client and a content owner is automatic when the licensing information of requested media contains automatic rates.

16. The method of claim 15, further comprising providing a contact form to the client when the request from the client does not contain automatic rates for licensing.

17. The method of claim 16, further comprising providing a contact form to the client to contact the content owner at the client's request.

18. The method of claim 17, wherein the user interface displays a catalog of media and search filters.

19. The method of claim 18, wherein the user interface is operable to save a playlist of media before requesting a license.

20. The method of claim 19, wherein automatic licensing rates are dependent on region and use.
